(19) United States
(12) Patent Application Publication
(10) Pub. No.: US 2006/0011805 A1
(43) Pub. Date: Jan. 19, 2006

(54) Method and device for recording the position of an object in space

(76) Inventor: Bernd Spruck, Mogglingen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/517,547

(22) PCT Filed: May 27, 2003
(86) PCT No.: PCT/EP03/05571

§ 371 Date: Sep. 7, 2005

(30) Foreign Application Priority Data
Jun. 13, 2002 (DE) 102 26 398.1

(51) Int. Cl. G01B 11/14

(52) U.S. Cl. 250/206.1; 356/623

(57) ABSTRACT

The invention relates to a method for recording the position of an object in space, comprising a fixing step in which three light sources are fixed to the object such as to define a triangle, an activation step, in which the light sources are switched on, a recording step in which the object, with switched on light sources, is simultaneously recorded from a first and a second position and an evaluation step in which the positions of the light sources are determined in the recordings and the position of the object calculated from the positions of the light sources.

The invention relates to a method and a device for sensing the spatial position of an object.

Such method is required, in particular, for what is known as HMD devices (Head Mounted Display devices), using which a viewer wears a display device on his head, said device generating images that he can perceive. For this purpose, the HMD device may be provided such that the viewer sees the generated image only, or that he perceives the generated image superimposed on the surroundings (so-called augmented reality). In particular, augmented reality requires that the viewer's movements and/or the position of his head be sensed continuously and be considered in generating the image, so as to realize said superposition in the best possible way.

For this purpose, magnetic methods are often used, which require exact measurement of a magnetic field (statically or dynamically). Magnetic methods have the disadvantage that any (ferro)metallic objects located in the area of observation influence the magnetic field and thus contribute to reduced precision. In particular, if said metallic objects are not statically located in one location, renewed calibration is also required in addition.

Furthermore, there are ultrasonic systems, which only have a limited resolution, however, due to the wavelength of use. Further, they are also highly susceptible to interference.

Further, there are systems comprising gyroscopes, but these are particularly complex.

In view thereof, it is an object of the invention to propose a method and a device for sensing the spatial position of an object, which require reduced complexity and exhibit high precision.

According to the invention, the object is achieved by a method of sensing the spatial position of an object, which comprises a mounting step in which three light sources are mounted on the object such that they define a triangle, an activating step in which the light sources are turned on, a recording step in which the object is recorded simultaneously from first and second positions, with light sources turned on, as well as an evaluating step in which the positions of the light sources in the recorded images are determined and the position of the object is computed on the basis of the determined positions of the light sources.

By simultaneously recording the object with turned-on light sources, all three of them being turned-on at the same time while recording, a pair of stereo images of the triangle defined by the light sources is generated, using which the spatial position (location and orientation) of the triangle can be determined in a known manner, in order to also determine the spatial position of the object therefrom.

The object may be, for example, a helmet or any other support for a display device of an HMD device which a viewer can mount on his head, said head-mounted condition enabling him to perceive images generated by means of the display device. Said support may also be provided, for example, in the manner of spectacles comprising two bows for both ears, and in the present case, three light sources defining a triangle may be provided at both, or only one, of said bows.

In particular, the method of the invention allows the images of the light sources to be separated from the remaining image background in order to determine the positions of the light sources. This provides a stereo pair of images having three isolated points (images of the light sources), which can be evaluated with particular ease.

The separation of the images of the light sources from the remaining image background may be carried out, for example, electronically. This enables electronic image processing wherein said separation is effected via the brightness or color of the recorded (turned-on) light sources.

Particularly preferably, the light sources are turned off prior to the evaluating step and the object is recorded, with the light sources turned off, from the first and second positions at the same time, with the image recorded while the light sources were turned off being subtracted from the images recorded while the light sources were turned on in the evaluating step, in order to determine the positions of the light sources for each recording position. In doing so, the entire image background is separated from the images of the light sources, so that a stereo pair of images comprising only three isolated points (images of the light sources) is present. Said subtraction of the images from each other is easily carried out using conventional image processing programs

A preferred embodiment of the method according to the invention consists in that, in the mounting step, more than three light sources are mounted on the object, of which only three light sources are turned on each time in the activating step. It can thus be ensured that three light sources can always be recorded at the same time from both positions, even during more extensive movements of the object.

In particular, if more than three light sources are mounted on the object, it is possible to always turn on those three light sources in the activating step which form the largest triangle that can be recorded from both positions. The largest triangle can be that triangle which has the largest area or the longest circumference. This increases the precision achievable in determining the position.

A particularly preferred embodiment of the method according to the invention consists in that the light sources are operated in a pulsed manner. In this case, it is particularly easy to always generate one image pair with turned-on light sources and one image pair with turned-off light sources, which image pairs can then be used to separate the image background from the images of the light sources.

Thus, images can be recorded synchronously using the light sources operated in a pulsed manner so as to record an image pair with turned-on light sources and an image pair with turned-off light sources in an alternating manner. Two consecutive image pairs (i.e. one image pair with turned-on light sources and one image pair with turned-off light sources) can then be used for the above-described separation of the image background (e.g. by suitable subtraction of the images).

Further, the light sources can be turned on and recorded individually, one after the other, in order to identify the light sources. This makes it particularly easy to identify the individual light sources in the recorded images by means of three turned-on light sources, thus ensuring that the position of the object is correctly determined.

In the method according to the invention, the light sources can be controlled in a wireless manner. This is advantageous, in particular, when applying the method of the invention to HMD devices, because undesired cable connections can be omitted.

A further embodiment of the method according to the invention consists in that the light sources, in the turned-on condition, emit light (or electromagnetic radiation, respectively) in the non-visible wavelength range (e.g. in the infrared range). This leads to the advantage that there is no blinking or illumination, respectively, of the light sources disturbing the viewer (e.g. in the case of an HMD device) carrying out said method.

The object is also achieved by a device for sensing the spatial position of an object, wherein the device comprises three light sources, which can be mounted on the object, two spaced apart image-recording devices, whose image-recording fields overlap, a control device which causes the light sources to be turned on and causes simultaneous recording of the object with turned on light sources by both image-recording devices, as well as an evaluating unit, which determines the position of the light sources in the recorded images and the position of the object on the basis of the determined positions of the light sources.

Using this device, the positions of the light sources and thus also the spatial position of the object can be easily determined by determining the positions of the light sources in the recorded images.

The control device and the evaluating unit can be realized by means of a conventional computer with suitable software.

An advantageous further embodiment of the device according to the invention consists in that the evaluating unit separates the images of the light sources from the remaining image background in order to determine the positions of the light sources. Such separation can be effected, in particular, electronically.

Thus, for example, the control device can have the effect that the light sources are turned off and, at the same time, the object is recorded with turned-off light sources by both image-recording devices, and, for each image-recording device, the evaluating unit can subtract the recorded image with turned-off light sources from the recorded image with turned-on light sources when determining the positions of the light sources. This is easy to do using conventional image-processing programs and leads to a stereo pair of images comprising three isolated points (images of the light sources). The position of the object is particularly easy to determine from said stereo light pair.

A preferred embodiment uses infrared diodes (IR diodes) as light sources on the object (e.g. on the helmet) and infrared-sensitive image pick-ups or image-recording devices, respectively. An infrared filter, through which only light having a wavelength of more than 830 nm can pass, is placed in front of each image pick-up. This results in a considerably darker representation of the typical surrounding light and, thus, of the recorded scene. However, since the wavelength of the IR diodes is 880 nm, the light of the IR diodes arrives at the image pick-up without hindrance as a strong useful signal. This measure clearly increases the ratio of useful signal to interference signal when subtracting the images, which also shows in a substantially improved contrast of the points isolated in the image.

A further specific embodiment of the invention makes use of the evaluation of the isolated points by means of a further image-analyzing measure, by analyzing the ensuing luminous spot (image of the light source in the recorded image) in relation to a center of gravitation. This results in a further substantial increase in the precision of the device according to the invention in position-determining.

Since the geometry of the light sources (e.g. light emitting diodes) has a direct influence on computing the center of gravity of the luminous spot, there is a further improvement according to the invention. Fo this purpose, the light sources (e.g. light emitting diodes) are buried in a cylindrical bore of a material (e.g. aluminum, for IR diodes) that is not transparent in the wavelength range of the light or of the radiation, respectively, from the light sources (e.g. in the infrared range in the case of IR diodes as light sources). The remaining circular, open surface of the bore is covered by a thin diffusor plate, for example, which has a wide scattering angle of e.g. 60°. This arrangement makes the luminous spot always appear as a circular or oval shape and the center of gravity is accordingly formed in a more precise manner.

At great distances of the light sources (e.g. light emitting diodes or IR diodes) from the image pick-up, these can be image-recording operated with a correspondingly stronger current, so that optimal contrasts are always achieved even at different distances. Thus, the brightness of the light sources (e.g. of the IR diodes) is controlled by a control circuit, which may be part of the control main circuit, in such a manner that a stronger current is imposed as the distance from the image pick-up or from the image-recording devices, respectively, increases. With reference to said distance, this may also be effected, for example, gradually with a certain hysteresis.

Further, in the device according to the invention, a control unit may be provided, which is connected with the light sources and controls the light sources on the basis of signals wirelessly transmitted by the device, wherein, in particular, a current or voltage source, respectively, is also provided for the light sources. This readily allows a portable design of the light-source arrangement together with the control unit, which is an advantage, in particular, in HMD devices.

A particularly preferred embodiment of the method according to the invention consists in that light emitting diodes. in particular infrared-light emitting diodes, are employed as light sources. Light emitting diodes are small and inexpensive light sources which, in addition, have a very long service life, thus allowing to ensure the reliability of the device according to the invention. The use of infrared-light emitting diodes also has the advantage that the emitted infrared radiation is not perceivable by a viewer and thus also not disturbing.

Further, in the device according to the invention, the object may comprise a display unit that can be mounted on a viewer's head and, in the mounted condition, can generate an image which is perceivable by the viewer. The display unit may be provided such that the observer can perceive the generated image only, or the generated image superimposed on the environment. In this way, an HMD device can be realized which allows easy and reliable determination of the position of the viewer's head.

In the device according to the invention, the light sources can be connected with the object in a fixed manner and define a triangle. This ensures that the position of the object can always be deduced from the position of the light sources (or the triangle of light sources, respectively).

In a further embodiment of the method according to the invention, it is possible that the light sources comprise a predetermined emission spectrum and the recording devices only record light having said predetermined emission spectrum. Thus, a separation of the image of the light sources from the image background is realized already during recording. This is possible, in particular, by the use of corresponding filters which are provided for each of said recording means and only allow the passage of light of the predetermined emission spectrum.

The invention is explained in more detail below, essentially by way of example, with reference to the drawings, wherein:

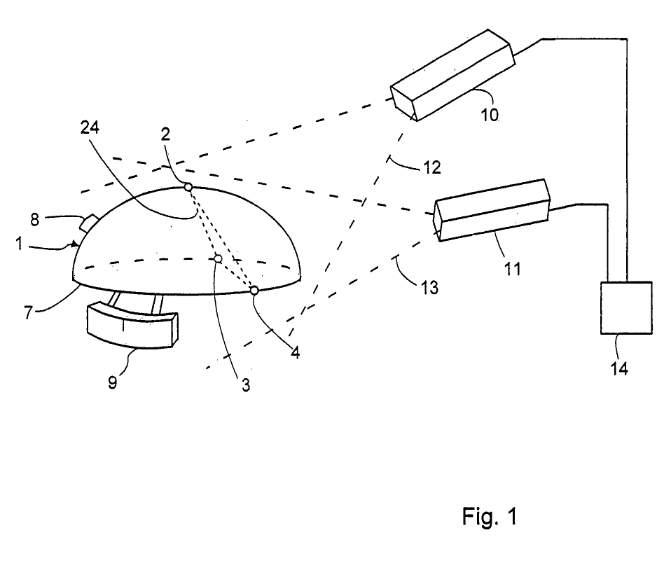

FIG. 1 schematically shows an embodiment of the device according to the invention in an HMD;

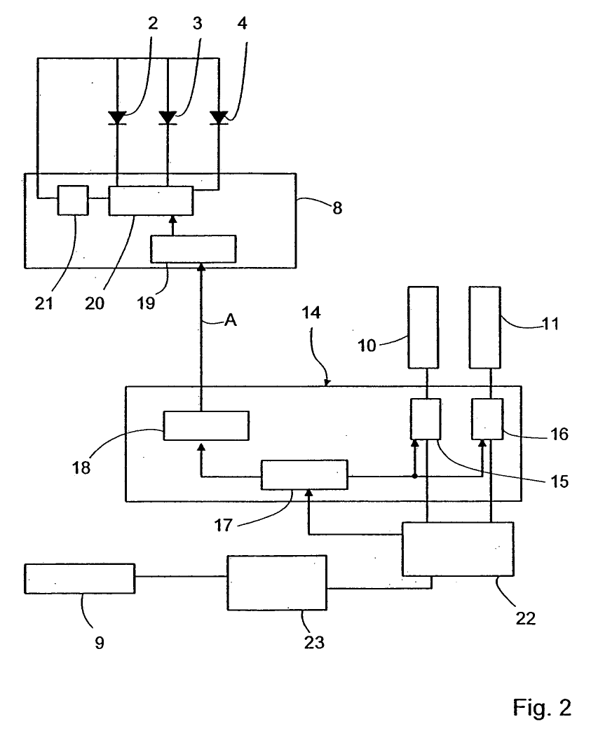

FIG. 2 schematically shows a simplified operational diagram of the device of FIG. 1, and

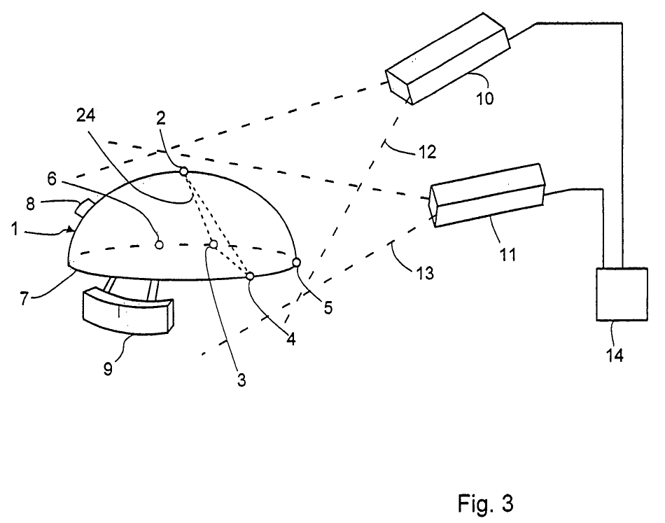

FIG. 3 schematically shows a further embodiment of the device according to the invention in an HMD.

The device according to the invention for sensing the spatial position of an object comprises a helmet 1 having three infrared-light emitting diodes 2, 3, and 4 mounted thereon, of which a first light emitting diode 2 is arranged on top of the helmet and the other two light emitting diodes 3 and 4 are arranged at the lower edge 7 of the helmet 1 with in offset of about 90° in the peripheral direction between them.

Further, a control unit 8 for the light emitting diodes 2 to 4 is provided on the helmet 1, which control unit will be described in more detail later.

A display unit 9 is mounted on the helmet 1 in such a manner that a viewer (not shown) wearing the helmet 1 can perceive the images generated by means of the display unit 9. The helmet 1 comprising the display unit 9 is a so-called HMD.

The device according to the invention further comprises two cameras 10, 11, which can record the helmet 1 or the light emitting diodes 2 to 4, respectively, from different positions. For this purpose, the cameras 10, 11 are arranged and designed such that their image-recording areas 12, 13 overlap at least partially and the overlapping region of both image-recording areas 12 and 13 covers the range of movement of the helmet 1 during its intended use.

The cameras 10 and 11 are controlled by means of a control device 14 as are the light emitting diodes 2 to 4.

As is evident, in particular, from FIG. 2, the control device 14 includes, for each of the cameras 10, 11, a digitizing unit 15, 16, which is controlled by a control module 17 of the control device 14.

Further, the control device 14 comprises a transmitter unit 18, via which the control module 17 wirelessly transmits control signals for the light diodes 2 to 4 to the control unit 8 (as indicated by the arrow A), which signals are received by a receiving unit 19 of the control unit 8.

In addition to the receiving unit 20, the control unit 8 comprises a control unit, which connects the light emitting diodes 2 to 4 with a voltage supply 21 of the control unit 8 as a function of the signals received.

The digitizing units 15 and 16 are connected with an evaluating unit 22, which uses the (digitized) images to compute the positions of the light emitting diodes 2 to 4 and then computes therefrom the position of the helmet 1 and thus the position of the viewer's head. The data relating to the position of the helmet 1 are supplied, by the evaluating unit 22, to the control module 17 as well as to a display control 23 of the display unit 9, so that, for example, the image generated by means of the display unit 9 can be positioned correctly in the environment that is still perceivable through the display unit 9.

The control device 14 and the evaluating unit 22 as well as the display control 23 can be realized by means of one or more computers with suitable software.

In operation, the light emitting diodes 2 to 4 are operated in a pulsed manner and are always turned on and off at the same time. In the embodiment shown in FIG. 1, the light emitting diodes 2 to 4 define the indicated triangle 24.

When the three light emitting diodes 2, 3 and 4 are turned on, an image of the helmet 1 is taken by both cameras 10 and 11, at the same time, with the turned-on light emitting diodes 2 to 4. The recorded images are digitized by means of the digitizing units 15 and 16 and stored in the evaluating unit 22.

The light emitting diodes 2 to 4 are turned off thereafter (by the pulsed operation) and the cameras 10 and 11 simultaneously record the helmet 1 with turned-off light emitting diodes 2 to 4. These images are again digitized as well by means of the digitizing units 15 and 16 and supplied to the evaluating unit 22.

The evaluating unit 22 then subtracts the image of the helmet taken by camera 10 with turned-off light emitting diodes 2 to 4 from the image of the helmet taken by camera 10 with turned-on light emitting diodes 2 to 4. Both images taken by camera 11 are subtracted from one another in the same manner, so that a stereo pair of images with, ideally, only three isolated points (the images of the light emitting diodes 2 to 4) is present, from which the spatial position of the triangle 24 defined by the light emitting diodes 2 to 4 can be computed by known methods taking into consideration the positions of both cameras 10 and 11. Since the light emitting diodes 2 to 4 are mounted on the helmet 1 and their exact positions on the helmet are known (for example, by means of a one-time calibration), the position (location and orientation) of the helmet 1 can be precisely determined.

Depending on the spatial position of the helmet 1 and thus also on the spatial position of the display unit 9, the display unit 9 is controlled as desired by means of the display control 23. Thus, for example, the (stereo) image generated by means of the display unit 9 can be generated such that it always appears at the same spatial location, independent of the movements of the viewer.

The light emitting diodes 2 to 4 are subsequently turned on again and are recorded, at the same time, by the cameras 10 and 11, and, in a subsequent turned-off state of the light emitting diodes, the helmet 1 is in turn recorded by both cameras 10 and 11. A stereo pair of images with three isolated points is in turn generated from these recorded images in the same manner as above.

Thus, the spatial position of the helmet 1 and, consequently, the spatial orientation of the viewer's head can be continuously determined.

It is also possible, of course, to first record the helmet 1 with turned-off light emitting diodes 2 to 4 and then the helmet 1 with turned-on light emitting diodes 2 to 4 and, in turn, to generate therefrom the stereo pair of images with the isolated points.

A further embodiment of the device according to the invention is shown in FIG. 3, which differs from that of FIG. 1 substantially only in that two further light emitting diodes 5 and 6 are arranged at the lower edge 7 of the helmet 1 such that they are also located in the overlapping region of the two image-recording areas 12 and 13 of the cameras 10 and 11. Identical elements of the embodiments shown in FIGS. 1 and 3 are identified by the same reference numerals and their description is not repeated.

Since four light emitting diodes 3 to 6 are provided at the lower edge 7 of the helmet 1 in the embodiment of FIG. 3, several different triangles can be generated in that the first light emitting diode 2 is always turned on in combination with two of the light emitting diodes 3 to 6 arranged at the lower edge 7 of the helmet 1.

The purpose of this may be, on the one hand, to illuminate the diode triangle by which the greatest precision can be achieved in the evaluation. This may be, for example, the diode triangle having the largest area or the longest circumference.

Alternatively, the diodes 2 to 6 can also be activated so as to create the impression of a diode triangle moving around the periphery of the helmet 1. For example, first the diodes 2, 4 and 5, then the diodes 2, 5 and 3, and then the diodes 2, 3 and 6 are activated. Then, the diode triangle 2, 4 and 5 is started with again. This generates a partial circulation of the diode triangle on the helmet 1. Such a circulatory method of activation of the diode triangles is particularly suitable, if a prediction of the movement of the helmet 1 is to be computed also by means of the evaluating unit 22.

Further light emitting diodes (not shown) at the lower edge 7 of the helmet 1 as well as further cameras (not shown) may be provided such that each triangle of light emitting diodes containing the light emitting diode 2 can be recorded by at least two different cameras at the same time. In this case, a diode triangle moving around the periphery of the helmet 1 can be generated which can always be evaluated with respect to the spatial position of the helmet 1, because it is always recorded by two cameras at the same time.

Furthermore, a synchronization of the evaluating unit 21 with the individual diodes 2 to 6 may be effected such that the diodes 2 to 6 are individually turned on and off, one after the other. Such synchronization can be effected at the beginning of the process, at regular time intervals or as required.

Instead of the cameras 10 and 11 as shown and the associated digitizing units 15 and 16, digital cameras may also be used, of course, so that the digitizing units 14, 15 and 16 no longer have to be provided separately.

1-17. (canceled)

18. A method of determining a spatial position of an object, comprising the steps of:
mounting three light sources on the object so that the three light sources define apices of a triangle;
illuminating the light sources;
simultaneously recording the object and the illuminated light sources from a first and a second position;
capturing the positions of the light sources in recorded images from the first and second positions; and
computing the position of the object based upon positions of the illuminated light sources in the recorded images.

19. The method as claimed in claim 18, further comprising the step of separating images of the illuminated light sources from a remaining image background.

20. The method as claimed in claim 18, further comprising the steps of:
extinguishing the light sources prior to the computing step;
recording the object from the first and second positions at the same time while the light sources are turned off;
subtracting the image recorded while the light sources were turned off from the image recorded while the light sources were turned on in the evaluating step to determine the positions of the light sources for each recording position.

21. The method as claimed in claim 18, wherein, in the mounting step, more than three light sources are mounted on the object and only three light sources are illuminated during the illuminating step.

22. The method as claimed in claim 21, further comprising the step of selecting the three light sources which define apices of a largest triangle that can be recorded from both positions and
illuminating the three light sources that define the apices of the largest triangle.

23. The method as claimed in claim 18, further comprising the step of operating the light sources in a pulsed manner.

24. The method as claimed in claim 23, further comprising the steps of:
synchronizing the simultaneous recording from both positions with the pulsed operation of the light sources such as to alternately obtain a first pair of recorded images with illuminated light sources and a second pair of recorded images with nonilluminated light sources; and
determining the light source positions on the basis of two subsequent pairs of first and second pairs of recorded images.

25. The method as claimed in claim 18, further comprising the steps of:
illuminating the light sources individually and sequentially; and
sequentially recording each individually illuminated light source to identify each light source.

26. The method as claimed in claim 18, further comprising the step of controlling the light sources in a wireless manner.

27. A device for sensing the spatial position of an object, said device comprising:
three light sources mounted on the object to define the apices of a triangle;
two spaced apart image-recording devices each having an image recording area, the image recording devices being oriented such that the image-recording areas overlap;
a control device capable of illuminating the light sources and activating the two recording devices simultaneously to record images the object and the illuminated light sources; and
an evaluating unit, capable of determining positions of the light sources in the recorded images and computing a position of the object on the basis of the determined positions of the light sources.

28. The device as claimed in claim 27, wherein the evaluating unit separates the images of the light sources from remaining image background to determine the positions of the light sources.

29. The device as claimed in claim 27, wherein the control device is capable of extinguishing the light sources and activating the recording devices to simultaneously record an image of the object with the light sources extinguished by both image-recording devices, and the evaluating unit is capable of subtracting the image recorded with the extinguished light sources from the image recorded with the illuminated light sources, to determine positions of the light sources.

30. The device as claimed in claim 27, further comprising a control unit operably connected to the light sources, the control unit being capable of controlling the light sources on the basis of signals wirelessly transmitted by the control device; and
a power supply for the light sources.

31. The device as claimed in claim 27, wherein the light sources comprise light emitting diodes.

32. The device as claimed in claim 27, wherein the light sources comprise infrared-light emitting diodes.

33. The device as claimed in claim 27, wherein the object comprises a head mountable display unit that can generate an image that is perceivable by a wearer of the head mountable display.

34. The device as claimed in claim 27, wherein the light sources are connected with the object in a stationary manner.

35. The device as claimed in claim 27, wherein the light sources emit light at a pre-determined emission spectrum and the recording devices selectively accept light within the pre-determined emission spectrum.

36. The device as claimed in claim 35, wherein each recording device further comprises a filter, said filter allowing light to pass only if it is within the pre-determined emission spectrum.
